(19) United States
(12) Patent Application Publication
(10) Pub. No.: US 2005/0097565 A1
(43) Pub. Date: May 5, 2005

(54) Gathering message information

(76) Inventor: Udo Klein, Maximiliansau (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/698,958

(22) Filed: Oct. 31, 2003

(51) Int. Cl. G06F 9/44

(52) U.S. Cl. 719/313

(57) ABSTRACT

Gathering information about a user message in a computer system may include detecting a user message identifier that a program uses in presenting a user message in a computer system where the program is being executed. The detected user message identifier may be used in storing information about the presented user message in a log that is accessible to a user of the computer system. The stored information may include how many messages have been generated, to which user names the message(s) were issued, a program or subroutine that triggered the message, and a status of a call stack when the message was issued. The message identifier(s) may be detected in a message handler, the kernel, or in another unit of the computer system.

### TECHNICAL FIELD

This description relates to gathering message information in a computer system.

### BACKGROUND

Most software applications include messages that can be presented to a user at certain times. User messages are often in form of a dialog box displayed on a computer screen to inform the user of something or to elicit input or information from the user. However, a particular system may include some user messages that are not very helpful to the user. Their language may be poorly drafted or out of date, or they may have been intended mainly for the benefit of developers. Larger applications can include a great number of user messages and it may be impracticable to overview what messages are actually generated by the system and when they are generated. Moreover, this problem may remain even if there is a so called “where used” list for the user messages in a particular application, because such lists typically specify which parts of the software code that can trigger a particular message, but have no information on whether or how often the code is actually executed. In addition, these lists relate to messages that are specified by the software code and do not cover dynamic messages that are not coded.

There exists coverage analyzers for software code that may track which portion(s) of the code the system actually executes. However, such analyzers do not track which message(s) the code generates or relevant information about the generated messages. The execution of a particular piece of software code may furthermore not be an absolute indicator that a message was generated, because such generation may depend on the presence or absence of other conditions that cannot be determined from the code. Code coverage analyzers also may not provide information on system status.

### SUMMARY

The invention relates to gathering message information. In a first general aspect, a method comprises detecting a user message identifier that a program uses in presenting a user message in a computer system where the program is being executed. The detected user message identifier is used in storing information about the presented user message in a log that is accessible to a user of the computer system.

In selected embodiments, the message identifier is detected in a message handler of the computer system. This may involve monitoring events in the message handler.

In selected embodiments, detecting the message identifier comprises introducing code in a kernel of the computer system to monitor messaging information. The messaging information in the kernel may comprise a message statement generated by the program.

In a second general aspect, a computer system comprises at least one program being executed, and a detection module detecting a user message identifier that the program uses in presenting a user message. The detection module stores information about the presented user message in a log that is accessible to a user of the computer system.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a computer system capable of gathering message information;

FIGS. 2 and 3 are exemplary logs generated by the system shown in FIG. 1; and

FIG. 4 is a flow chart of a method of gathering message information.

Like reference numerals in the various drawings indicate like elements.

### DETAILED DESCRIPTION

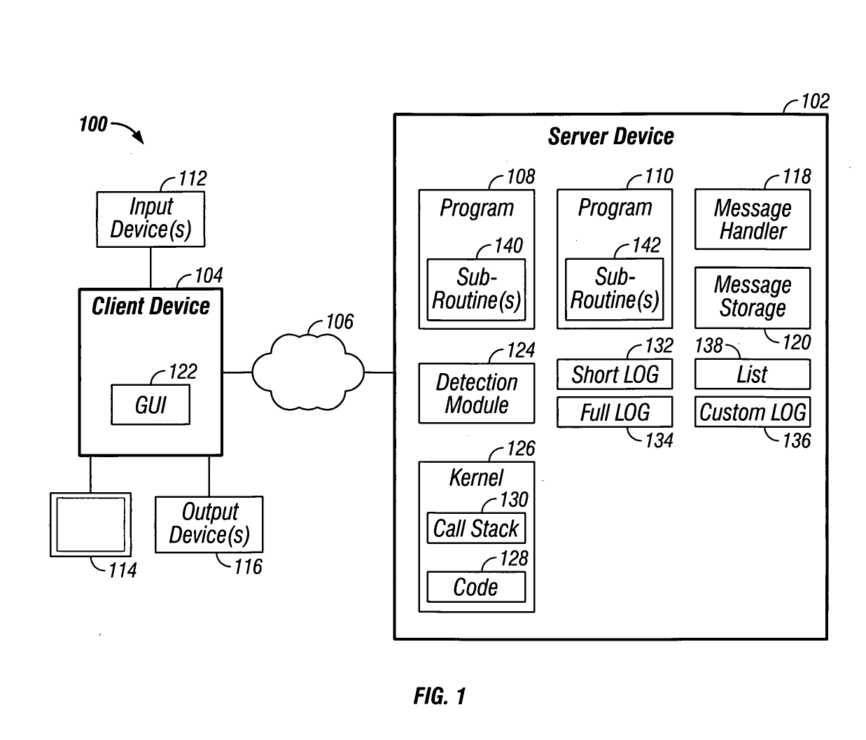

FIG. 1 schematically shows a computer system 100 including a server device 102 and a client device 104 connected by a network 106. A user of the client device 104 can interact with one or more programs 108 and 110 using input device(s) 112, a display device 114 and output device(s) 116 operably connected to the client device 104. Particularly, the system 100 is capable of gathering information about one or more messages presented to the user as will be described below.

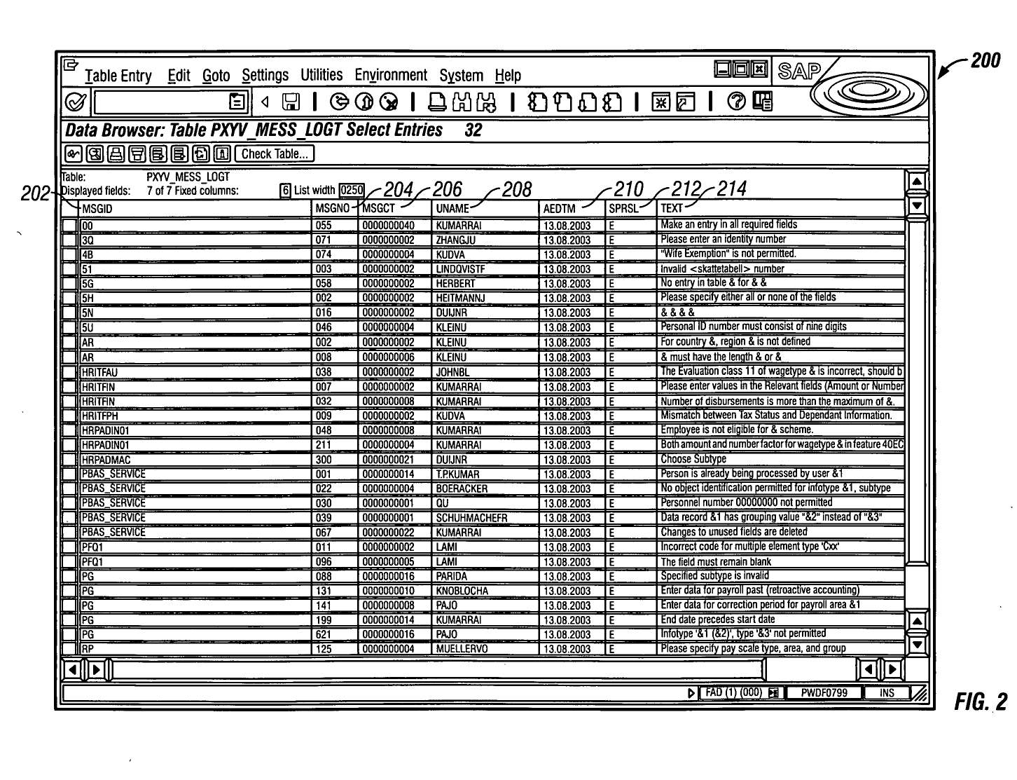

The following is an example of how a user message may be presented while the program 108 is being executed in system 100. The user makes an input using the input device(s) 112, such as a keyboard or a pointing device. The input is transmitted to the server device 102, where it is received and processed in the execution of program 108. In this example, the user input triggers the program 108 to issue a user message, perhaps because the input was of an improper format or because the program 108 is configured to ask the user for confirmation before carrying out certain operations. The user message that is to be presented may be handled through one or more events in a message handler 118 on the server device 102. Typically, a message identifier 204 (see FIG. 2) identifies the message. The message identifier may be a number, a character string, or any other information that serves to identify the message. Using the message identifier 204, a text 214 (see FIG. 2) of the message (assuming it is a written message) can be retrieved from a message storage 120 on the server device 102. The server device 102 transmits the user message to the client device 104 where it is to be presented to the user. A visual message can be presented on the display device 114 using a graphical user interface (GUI) 122. Other types of user messages can be presented to the user through output device(s) 116, such as a speaker.

More than one person can use the program(s) 108 at the same time if there is more than one client device connected to the server device 102. Various user messages may then be presented to the different users depending on how they interact with the program(s).

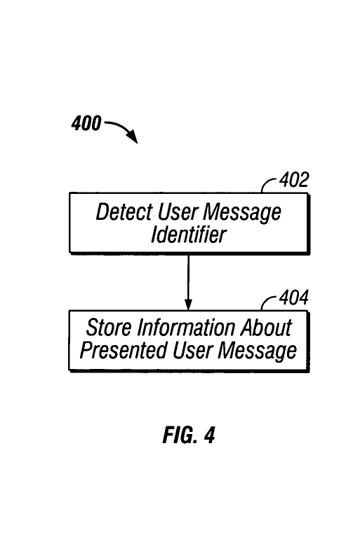

The server device 102 includes a detection module 124 that detects 402 (see FIG. 4) a user message identifier relating to the presented message and stores 404 (see FIG. 4) information about the message. If the detection module 124 is used to monitor user messages for a period of time, it can gather information about a relatively large number of messages. The gathered user message information can optionally be used in analyzing the operation of the server device 102, and particularly of the program 108 or 110, which triggered the message. The information may provide insight on whether any of the messages that the program(s) can generate need(s) revision. For example, it may be decided to modify a specific user-unfriendly message because it appears very often but to do nothing about another flawed message because it is almost never generated.

The detection module 124 may monitor the message handler 118 to detect the user message identifier(s). Particularly, where the presentation of a user message is associated with one or more events in the message handler 118 the detection module 124 may monitor events in the message handler that relate to presentation of user messages. Preferably, the detection module 124 does not affect the operation of the message handler 118 and the programs 108, 110; that is, these components should not “notice” the detection.

In other implementations, for example those where no message handler 118 exists, the detection may take place in another unit of the computer system 100 where user message identifiers 204—preferably a majority of them—can be detected. One example involves monitoring information in a kernel 126 of the server device 102. Code 128 may be introduced in the kernel 126 to monitor messaging information there. Such messaging information may include message statements that relate to messages generated by one or more of the programs 108 and 110. Particularly, the kernel 126 may include a call stack 130 that keeps track of calls made in the system 100, such as calls made by one or more subroutines 140, 142 in programs 108, 110. The detection module 124 may store information about presented user messages retrieved from the call stack 130.

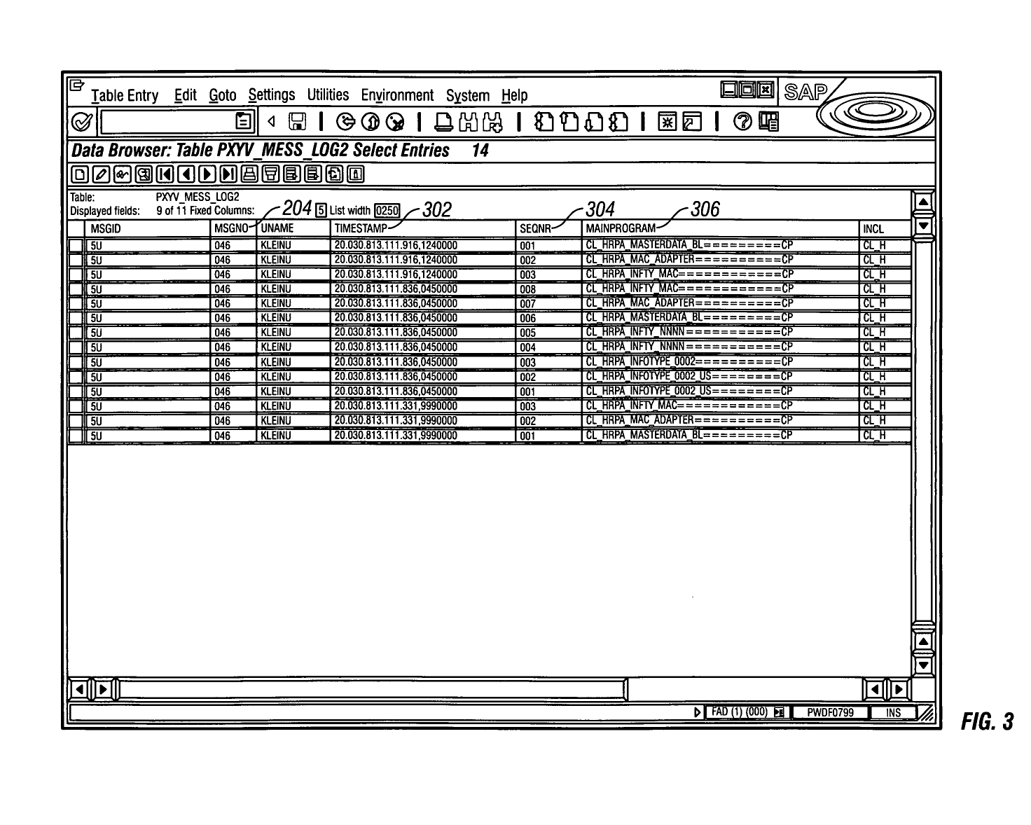

The detection module 124 may store information about presented user messages in a log that is accessible to a user of the server device 102. In this example, the detection module 124 can store message information in any of logs 132, 134 and 136 on the server device 102. Panel 200 in FIG. 2 is an example of how the system 100 can display a custom log 136 and panel 300 in FIG. 3 is an example of how the system 100 can display a full log 134. For example, the logs may be displayed on client device 104 using display device 114 or on another device connected to the server device 102.

One difference between the logs in this example is how much information about each message is stored. A user may define the custom log 136 such that the detection module stores message information other than what is stored in the short and full logs, optionally together with any or all of their types of information. Different levels of information granularity in the logs may facilitate different levels of diagnostics on the generation of user messages.

The detection module 124 may access a list 138 for specific instructions. The list 138 may specify for which user messages the detection module 124 should store message information. Accordingly, based on information in the list 138 the detection module 124 may ignore certain user messages. As another example, the list 138 may specify what information about a particular message is to be stored. The list may do this by specifying in which of the logs 132, 134 and 136 to store information about the message(s). One of the logs, such as short log 134, may be a default log for storing information about any user message for which the list 138 does not specify a different log.

The panel 200 in FIG. 2 contains respective columns for user message areas 202, message identifiers 204 (here, a unique number identifying the message), numbers 206 of generated messages for each identifier, user names 208 in the system 100 to whom the user messages were presented, dates 210 when the messages were (most recently) presented, language keys 212, and texts 214 of the user messages. In this example, message information was gathered while several user names 208 were using the system 100.

The user message areas 202 and message identifiers 204 are labeled “MSGID” and “MSGNO”, respectively, in this exemplary embodiment. For reasons not important to this description, the programs 108, 110 may use two or more items collectively as a name for the user message, such as the message area 202 and message identifier 204 in this implementation. What the detection module 124 detects, on the other hand, may be anything that uniquely identifies a presented message; in this example, the message identifiers 204.

The language keys 212 indicate the system language in which the messages were issued, here English (“E”). Thus, the gathered message information can for example be used to determine whether any of the language keys 212 is inconsistent with its corresponding text 214.

Any of the information in panel 200 (and hence in any of the logs 132, 134 and 136) may be continually updated. For example, if the detection module 124 detects that an additional message is being presented, it may find the entry for that message in the log (optionally by first referring to list 138), and increase the number 206 for that message by one. If the message is not listed in the log, the message may be added as a new row and its information be entered accordingly. The short log 134 may include selected portions of this information for the messages registered in that log, such as everything except the language keys 212 and text 214 columns.

The panel 300 can be displayed based on information in the full log 134, which may store more detailed information regarding messages than logs 132, 136. In this example, only messages having the same message identifier 204 are listed, and they are distinguished by their different time stamps 302 or sequence numbers 304. For messages having identical time stamps 302, the sequence numbers 304 indicate an order in which the messages were generated. The panel 300 indicates for each message which program 306 caused the message to be presented. As an example, the information in panel 300 may have been obtained from the call stack 130.

In other implementations, any or all of the logs 132, 134 and 136 may also or instead list other information. Such information may include an event that triggered the user message, information on where in the computer system 100 the message was triggered, such as which subroutine(s) 140 or 142 triggered the message, or a status of a system flag in the system 100 when the message was generated.

FIG. 4 is a flow chart of a method 400 for gathering message information. Preferably, method 400 is executed by a server device. For example, a computer program product can include instructions that cause a processor of the server device to execute the steps of method 400. Method 400 for gathering message information includes the following steps:
Detecting 402 a user message identifier 204 that a program 108, 110 uses in presenting a user message in a computer system 100 where the program 108, 110 is being executed.
Using the detected user message identifier 204 in storing 404 information 200, 300 about the presented user message in a log 132, 134, 136 that is accessible to a user of the computer system 100.

Gathering the various types of message information described above may facilitate useful analyses of the message generation in system 100. For example, the number 206 of generated messages for each type indicates how often messages are generated, which in turn may aid a decision on whether the message needs revision. Other information, such as the program or subroutine that caused the message to be generated, may aid a revision of a message and the understanding of unexpected behavior in the system 100. As an example, information from the call stack 130 may allow tracing of the calls made by any of programs 108, 110 or subroutines 140, 142 that resulted in a user message being generated.

Advantages of gathering message information as described herein may include one or more of the following. Facilitating improved diagnostics of programs and systems. Determining what user messages are being generated in a system. Providing that message analysis can be performed in parallel with integration and application tests. Guiding targeted revision of those user messages that need it most. Obtaining detailed statistical analysis regarding the generation of user messages. Providing that events leading up to a user message being presented can be traced. Offering useful assemblies of information regarding presented user messages including how often a message consisting of a given text is presented in a system.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A method of gathering information about a user message, the method comprising:
detecting a user message identifier that a program uses in presenting a user message in a computer system where the program is being executed; and
using the detected user message identifier in storing information about the presented user message in a log that is accessible to a user of the computer system.

2. The method of claim 1, wherein the user message identifier is detected in a unit of the computer system where a majority of user message identifiers can be detected.

3. The method of claim 1, further comprising detecting a second user message identifier used by a second program in presenting a second user message, and storing information about the second user message in the log.

4. The method of claim 1, further comprising accessing a list that identifies the information about the presented user message that is to be stored in the log.

5. The method of claim 4, wherein the information is to be stored in one of at least two logs and one of the logs is a default log, further comprising storing the information in the default log for messages where the list does not specify one of the logs.

6. The method of claim 4, wherein the list specifies that information about a particular user message is not to be stored.

7. The method of claim 1, wherein the stored information includes one selected from the group consisting of: the user message identifier, how many messages associated with the user message identifier have been presented, to which user in the computer system the user message was presented, a date when the user message was presented, and combinations thereof.

8. The method of claim 1, wherein the stored information comprises a text of the presented user message.

9. The method of claim 8, further comprising determining the text by accessing a storage of message texts.

10. The method of claim 1, wherein the stored information comprises one selected from the group consisting of: a sequence number of the presented user message, a name of the program, an event that triggered the program to present the user message, information on where in the computer system the user message was triggered, a system flag status when the message was triggered, and combinations thereof.

11. The method of claim 1, wherein detecting the user message identifier comprises introducing code in a kernel of the computer system, which code when executed monitors messaging information in the kernel.

12. The method of claim 11, wherein the messaging information comprises at least one message statement generated by the program.

13. The method of claim 11, wherein the stored information comprises information from a call stack in the kernel.

14. The method of claim 1, wherein the user message identifier is detected in a message handler of the computer system.

15. The method of claim 14, wherein the user message identifier is detected by monitoring events in the message handler.

16. A computer program product containing executable instructions that when executed cause a processor to perform operations comprising:
detect a user message identifier that a program uses in presenting a user message in a computer system where the program is being executed; and
use the detected user message identifier in storing information about the presented user message in a log that is accessible to a user of the computer system.

17. The computer program product of claim 16, wherein the operations further comprise:
access a list that identifies the information that is to be stored.

18. The computer program product of claim 17, wherein the information is to be stored in one of at least two logs and one of the logs is a default log, and wherein the operations further comprise:
store the information in the default log if the list does not specify the other log.

19. The computer program product of claim 16, wherein detecting the user message identifier comprises executing code in a kernel of the computer system to monitor messaging information in the kernel.

20. The computer program product of claim 16, wherein the user message identifier is detected in a message handler of the computer system.

21. A computer system comprising:
at least one program being executed; and
a detection module detecting a user message identifier that the program uses in presenting a user message, the detection module storing information about the presented user message in a log that is accessible to a user of the computer system.

22. The computer system of claim 21, further comprising code introduced in a kernel of the computer system to monitor messaging information in the kernel, wherein the detection module detects the user message identifier using the messaging information.

23. The computer system of claim 21, further comprising a message handling module that manages messages in the computer system, wherein the detection module detects the user message identifier in monitoring the message handling module.
